(19) United States
(12) Patent Application Publication
(10) Pub. No.: US 2025/0185873 A1
(43) Pub. Date: Jun. 12, 2025

(54) DISHWASHER AND METHOD FOR CONTROLLING THE SAME

(71) Applicant: Samsung Electronics Co., Ltd., Suwon-si (KR)

(72) Inventors: Gimun GWAK, Suwon-si (KR); Jungha PARK, Suwon-si (KR); Jongho LEE, Suwon-si (KR); Chulwoo PARK, Suwon-si (KR); Sujin SEONG, Suwon-si (KR); Jisun YANG, Suwon-si (KR); Hyunjun CHUNG, Suwon-si (KR)

(21) Appl. No.: 18/967,221

(22) Filed: Dec. 3, 2024

Related U.S. Application Data
(63) Continuation of application No. PCT/KR2024/096463, filed on Nov. 13, 2024.

(30) Foreign Application Priority Data
Dec. 12, 2023 (KR) 10-2023-0179961

(51) Int. Cl. A47L 15/00; A47L 15/42; C02F 1/00; C02F 1/46; C02F 1/469

(52) U.S. Cl. CPC A47L 15/0057; A47L 15/4202; A47L 15/4217; A47L 15/4297; C02F 1/001; C02F 1/4602; C02F 1/469; A47L 2401/10; A47L 2501/01; A47L 2501/02; C02F 2201/005; C02F 2209/11; C02F 2209/40; C02F 2303/16; C02F 2307/12

(57) ABSTRACT

A dishwasher according to an embodiment of the disclosure may include: a cabinet; a tub disposed in the cabinet; a sump disposed below the tub; a deionizer comprising at least one electrode configured to produce soft water using raw water supplied from a water source, and supply the soft water to the sump; a plurality of flow paths including at least one pipe and/or at least one hose configured to allow the raw water, the soft water, and used water collected in the sump to flow; a plurality of valves disposed in each of the plurality of flow paths; and a controller including at least one processor, comprising processing circuitry, individually and/or collectively, configured to control the plurality of valves to allow the deionizer to be regenerated using the raw water or the used water, in at least one of a washing process or a rinsing process.

### CROSS-REFERENCE TO RELATED APPLICATIONS

This application is a continuation of International Application No. PCT/KR2024/096463 designating the United States, filed on Nov. 13, 2024, in the Korean Intellectual Property Receiving Office and claiming priority to Korean Patent Application No. 10-2023-0179961, filed on Dec. 12, 2023, in the Korean Intellectual Property Office, the disclosures of each of which are incorporated by reference herein in their entireties.

### BACKGROUND

### Field

The disclosure relates to a dishwasher and a method for controlling the same.

### Description of Related Art

In general, a dishwasher may refer to a device for cleaning dishes received therein by spraying water at high pressure and then drying the dishes. The dishwasher operates by spraying water at high pressure into a tub where the dishes are placed, and the sprayed water reaches the dishes to wash off dirt, such as food residue, from the surface of the dishes.

For example, the dishwasher includes a tub with the tub formed therein and a sump installed below the tub to store water for dishwashing. The water is moved into a spray nozzle by pumping action of a washing pump installed in the sump, and the water moved into the spray nozzle is sprayed at high pressure through a spray outlet formed at an end of the spray nozzle. The water sprayed at high pressure hits the surface of the dish to cause dirt such as food residue on the dish to fall to the bottom of the tub.

The dishwasher may include a deionizer capable of converting raw water supplied from a water source to soft water. The deionizer may produce soft water by adsorbing ionic substances contained in the raw water. The deionizer is limited in its adsorption capacity by its capacitance and requires periodic regeneration.

### SUMMARY

Embodiments of the disclosure provide a dishwasher that may regenerate a deionizer using raw water from a water source or water used for dishwashing without a separate water tank, and a method for controlling the same.

Embodiments of the disclosure provide a dishwasher that may regenerate a deionizer while a washing course for dishwashing is performed, and a method for controlling the same.

According to an example embodiment of the disclosure, a dishwasher may include: a cabinet; a tub disposed in the cabinet; a sump disposed below the tub; a deionizer configured to produce soft water using raw water supplied from a water source, and to supply the soft water to the sump; a plurality of flow paths comprising a pipe and/or a hose configured to allow the raw water, the soft water, and used water collected in the sump to flow; a plurality of valves disposed in each of the plurality of flow paths; and a controller comprising at least one processor, comprising processing circuitry, individually and/or collectively, configured to control the plurality of valves to allow the deionizer to be regenerated using the raw water or the used water, in at least one of a washing process or a rinsing process.

According to an example embodiment of the disclosure, in a method for controlling a dishwasher including a tub, a sump disposed below the tub, a deionizer configured to produce soft water using raw water supplied from a water source and supply the soft water to the sump, a plurality of flow paths comprising a pipe and/or a hose configured to allow the raw water, the soft water, and used water collected in the sump to flow, and a controller comprising at least one processor comprising processing circuitry, the method may include: supplying the soft water to the sump by controlling the deionizer and a plurality of valves arranged on the plurality of flow paths by the controller in a washing process and a rinsing process, to wash dishes placed in the tub; and performing regeneration of the deionizer using the raw water or the used water in at least one of the washing process or the rinsing process, by controlling the plurality of valves by the controller.

According to various example embodiments of the disclosure, a dishwasher and a method for controlling the same may regenerate a deionizer using raw water from a water source or water used for dishwashing without a separate water tank. The dishwasher may have a relatively compact structure, and may be easily managed hygienically by omitting the water tank. In addition, using the water used for dishwashing to regenerate the deionizer, the use of raw water may be reduced.

According to various example embodiments of the disclosure, a dishwasher and a method for controlling the same may regenerate a deionizer while a washing course for dishwashing is performed. Dishwashing and deionizer regeneration may be performed simultaneously, thereby eliminating additional time for the deionizer regeneration and improving user convenience.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a cross-sectional view of a dishwasher according to various embodiments;

FIG. 2 is a perspective view illustrating an inside of a dishwasher according to various embodiments;

FIG. 3 is a perspective view illustrating various components of a dishwasher according to various embodiments;

FIG. 4 is an exploded perspective view illustrating a sump, a deionizer, and a case brake of a dishwasher according to various embodiments;

FIG. 5 is a cross-sectional view illustrating an inside of a case brake according to various embodiments;

FIG. 6 is a diagram illustrating a dishwasher including various flow paths and valves according to various embodiments;

FIG. 7 is a diagram illustrating a dishwasher including various flow paths and valves according to various embodiments;

FIG. 8 is a diagram illustrating a principle of producing soft water by a deionizer according to various embodiments;

FIG. 9 is a diagram illustrating a principle of regenerating a deionizer according to various embodiments;

FIG. 10 is a block diagram illustrating an example configuration of a dishwasher according to various embodiments;

FIG. 11 is a table illustrating operations of various valves included in a dishwasher according to various embodiments;

FIG. 12 is a diagram illustrating a soft water path for supplying soft water to a sump in a washing process and a rinsing process according to various embodiments;

FIG. 13 is a diagram illustrating a drainage path for discharging used water to an outside in a washing process and a rinsing process according to various embodiments;

FIG. 14 is a diagram illustrating a flow path used for regenerating a deionizer using raw water according to various embodiments;

FIG. 15 is a diagram illustrating a flow path used for regenerating a deionizer using used water according to various embodiments;

FIG. 16 is a flowchart illustrating an example process performed by a dishwasher to wash dishes according to various embodiments;

FIG. 17 is a flowchart illustrating an example method for controlling the dishwasher performed to regenerate a deionizer in a washing process and a rinsing process illustrated in FIG. 16 according to various embodiments;

FIG. 18 is a flowchart illustrating an example method for controlling the dishwasher illustrated in FIG. 17 according to various embodiments; and

FIG. 19 is a flowchart illustrating an example method for controlling the dishwasher performed to regenerate the deionizer in the rinsing process illustrated in FIG. 16 according to various embodiments.

### DETAILED DESCRIPTION

Various embodiments and the terms used therein are not intended to limit the technology disclosed herein to specific forms, and the disclosure should be understood to include various modifications, equivalents, and/or alternatives to the corresponding embodiments.

In describing the drawings, similar reference numerals may be used to designate similar elements.

A singular expression may include a plural expression unless otherwise indicated herein or clearly contradicted by context.

The expressions “A or B,” “at least one of A or/and B,” or “one or more of A or/and B,” A, B or C,” “at least one of A, B or/and C,” or “one or more of A, B or/and C,” and the like used herein may include any and all combinations of one or more of the associated listed items.

The term of “and/or” includes a plurality of combinations of relevant items or any one item among a plurality of relevant items.

Herein, the expressions “a first”, “a second”, “the first”, “the second”, etc., may simply be used to distinguish an element from other elements, but is not limited to another aspect (e.g., importance or order) of elements.

When an element (e.g., a first element) is referred to as being “(functionally or communicatively) coupled,” or “connected” to another element (e.g., a second element), the first element may be connected to the second element, directly (e.g., wired), wirelessly, or through a third element.

In this disclosure, the terms “including”, “having”, and the like are used to specify features, numbers, steps, operations, elements, components, or combinations thereof, but do not preclude the presence or addition of one or more of the features, elements, steps, operations, elements, components, or combinations thereof.

When an element is said to be “connected”, “coupled”, “supported” or “contacted” with another element, this includes not only when elements are directly connected, coupled, supported or contacted, but also when elements are indirectly connected, coupled, supported or contacted through a third element.

Throughout the disclosure, when an element is “on” another element, this includes not only when the element is in contact with the other element, but also when there is another element between the two elements.

Hereinafter, various example embodiments of the disclosure will be described in greater detail with reference to the accompanying drawings.

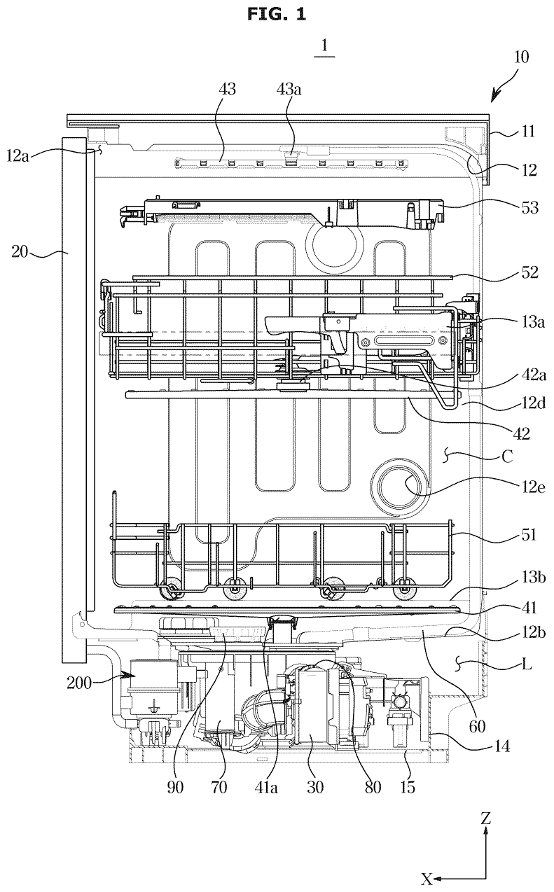

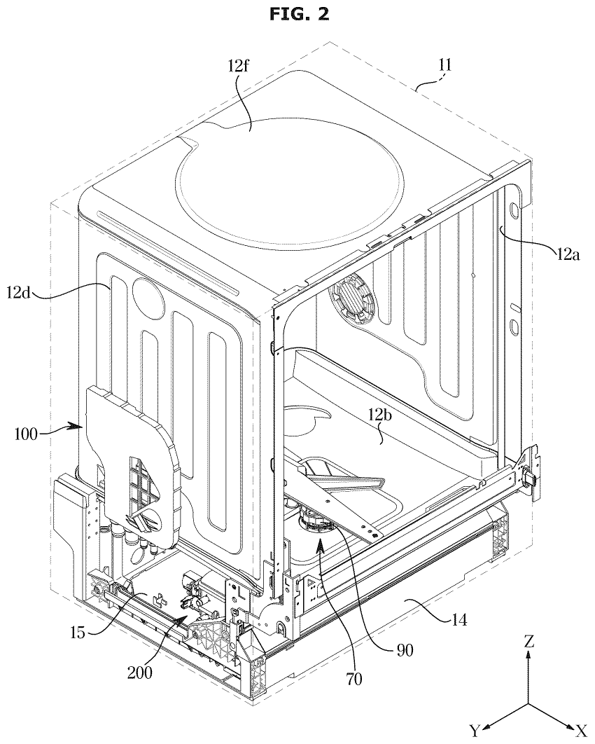

FIG. 1 is a cross-sectional view of a dishwasher according to various embodiments. FIG. 2 is a perspective view illustrating an inside of a dishwasher according to various embodiments.

Referring to FIG. 1 and FIG. 2, the dishwasher 1 may include a main body 10 that defines an exterior of the dishwasher 1. The main body 10 may include a cabinet 11 that defines an exterior of the dishwasher and a tub 12 disposed in the cabinet 11. The tub 12 may be shaped substantially like a box, without being limited thereto. One side of the tub 12 may be opened. For example, the tub 12 may include an open portion 12a. For example, a front side of the tub 12 may be opened.

The dishwasher 1 may further include a door 20 arranged to open or close the open portion 12a of the tub 12. The door 20 may be installed on the main body 10 to open or close the open portion 12a of the tub 12. The door 20 may be installed on the cabinet 11 to be pivotable.

The dishwasher 1 may include a storage container in the tub 12 to receive dishes. The storage container may include a plurality of baskets 51, 52 and 53. The plurality of baskets 51, 52 and 53 may accommodate various dishes. Both relatively large volume dishes as well as relatively small volume dishes may be accommodated in the plurality of baskets 51, 52 and 53. However, various types of the dishes may be accommodated in the plurality of baskets 51, 52 and 53. For example, various types of utensils such as plates, bowls, pots, frying pans, spoons, chopsticks, and knives may be accommodated in the tub 12.

The plurality of baskets 51, 52 and 53 may include the middle basket 52 located in the middle in a direction of the height of the dishwasher 1 and the lower basket 51 located in a lower part in the direction of the height of the dishwasher 1. The middle basket 52 may be supported on a middle guide rack 13a, and the lower basket 51 may be supported on a lower guide rack 13b. The middle guide rack 13a and the lower guide rack 13b may be installed on an inner side of the tub 12 to be slidable toward the open portion 12a of the tub 12.

The plurality of baskets 51, 52 and 53 may include the upper basket 53 located in an upper part in the direction of height of the dishwasher 1. The upper basket 53 may be formed in the shape of a rack assembly to receive relatively small volume dishes. For example, the upper basket 53 may receive cooking utensils or cutlery, such as ladles, knives, turners, and the like. However, the types of dishes to be received in the upper basket 53 are not limited thereto.

The dishwasher 1 may include a washing chamber C, which is a space formed by the inside of the tub 12. The washing chamber C is a room where the dishes in the baskets 51, 52 and 53 may be washed by water and dried. The washing chamber C may be defined as an interior space of the tub 12 formed by a top 12f, a side 12d, a front side, a rear side 12c, a bottom 12b of the tub 12, and a sump 70.

The dishwasher 1 may further include spraying units 41, 42 and 43 to spray water. The spraying units 41, 42 and 43 may include the first spraying unit 41 disposed under the lower basket 51 in the direction of height of the dishwasher 1, the second spraying unit 42 disposed under the middle basket 52 in the direction of height of the dishwasher 1, and the third spraying unit 43 disposed above the upper basket 53 in the direction of height of the dishwasher 1. Each of the spraying units 41, 42, and 43 may have a rod shape, and may include a nozzle through which water is sprayed.

The first spraying unit 41 may be rotatable on a first rotation axis 41a, the second spraying unit 42 may be rotatable on a second rotation axis 42a, and the third spraying unit 43 may be rotatable on a third rotation axis 43a.

The first spraying unit 41 may be fixed on the bottom 12b of the tub unlike the second spraying unit 42 and the third spraying unit 43. The first spraying unit 41 may be coupled to the sump 70. The first spraying unit 41 may spray water upward. The second spraying unit 42 may spray water toward the dishes received in the middle basket 52 and the upper basket 53. The third spraying unit 43 may spray water toward the dishes received in the lower basket 51, the middle basket 52 and the upper basket 53.

The dishwasher 1 may include a circulation pump 30 for pumping water stored in the sump 70 to the spraying units 41, 42 and 43. The water pumped by the circulation pump 30 may be sprayed into the tub 12 by the first spraying unit 41 through an alternator 80 connected to the circulation pump 30. In addition, the water pumped by the circulation pump 30 may be moved upward along a duct 60, and may be sprayed into the tub 12 by the second spraying unit 42 and the third spraying unit 43.

The water stored in the sump 70 may flow to the alternator 80 by the circulation pump 30. The alternator 80 may be connected to the first spraying unit 41, and may supply water to the first spraying unit 41. In addition, the alternator 80 may be connected to the duct 60, and may supply water to the duct 60. The alternator 80 may selectively supply water to at least one of the first spraying unit 41 or the duct 60.

The sump 70 may store soft water used for dishwashing. In a case where a defined (preset) amount of soft water is stored in the sump 70, the soft water may be sprayed toward the dishes. The soft water sprayed into the tub 12 may fall to the bottom 12b of the tub 12 together with the dirt on the dishes and may be collected in the sump 70. The water collected in the sump 70 may be sprayed again into the tub 12 through the spraying units 41, 42, and 43. The soft water used for dishwashing may be referred to as ‘used water’. The used water may be discharged to the outside during a draining operation of a washing process or draining operation of a rinsing process.

The sump 70 may be equipped with a drain filter 90. The drain filter 90 may be connected to a drain 73 of the sump 70. The drain filter 90 may filter impurities (dirt) contained in the used water. Accordingly, a contamination level of the used water discharged through the drain 73 of the sump 70 may be relatively low. Various types of drain filter 90 may be used. The drain filter 90 may be replaced by a user.

The dishwasher 1 may include a machine room L positioned below the tub 12. The machine room L may be formed by a lower frame 14 and a bottom plate 15. In the machine room L, a variety of components, such as the circulation pump 30, the sump 70, a drain pump 77, the alternator 80, a deionizer 80, and the like, may be arranged. In addition, a plurality of flow paths through which raw water, soft water and used water flow may be arranged. Each of the plurality of flow paths may be provided as a pipe or a hose.

The dishwasher 1 may include a case brake 100. The case brake 100 may be coupled onto the side 12d of the tub 12. For example, the case brake 100 may be coupled onto an outer side of the tub. The case brake 100 may be connected to a hole 12e formed on the side 12d of the tub 12. The case brake 100 may be coupled onto the side 12d of the tub 12 in such a way that the hole 12e of the tub 12 corresponds to a tub connection hole 113 of the case brake 100.

The dishwasher 1 may include the deionizer 200. The deionizer 200 may be disposed below the tub 12. The deionizer 200 may be disposed below the bottom 12b of the tub. The deionizer 200 may be accommodated in the cabinet 11.

The deionizer 200 may be supplied with raw water from an external water source. The case brake 100 may be connected to the deionizer 200, and the raw water supplied from the water source may flow into the deionizer 200. The deionizer 200 may produce soft water by adsorbing ionic substances contained in the raw water.

The deionizer 200 may be provided in various types. For example, the deionizer 200 may include an electro deionization (EDI) device, a continuous electro deionization (CEDI) device, and/or a capacitive deionization (CDI) device.

The soft water produced by the deionizer 200 may flow to the case brake 100. In addition, the case brake 100 may be connected to the sump 70, and the used water may flow from the sump 70 to the case brake 100. Waste water generated by regeneration of the deionizer 200 may also flow to the case brake 100.

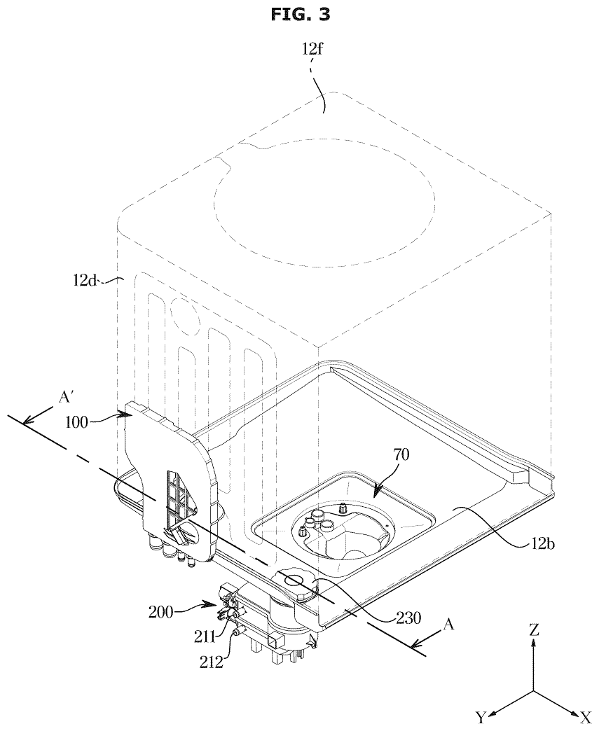

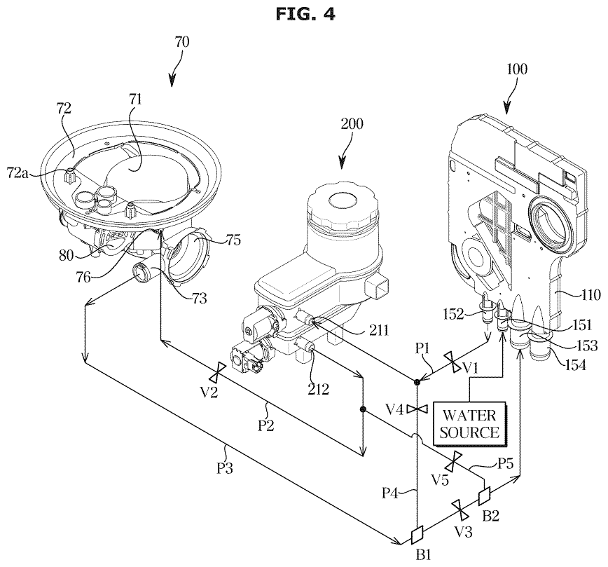

FIG. 3 is a perspective view illustrating various components of a dishwasher according to various embodiments. FIG. 4 is an exploded perspective view illustrating a sump, a deionizer, and a case brake of a dishwasher according to various embodiments.

Referring to FIG. 3 and FIG. 4, the dishwasher 1 may include the tub 12, the sump 70, the case brake 100, and the deionizer 200. The case brake 100, the sump 70, and the deionizer 200 may be connected by a plurality of flow paths. The plurality of flow paths may be provided as pipes or hoses. In addition, a plurality of valves may be provided for opening or closing the plurality of flow paths. The valves may include solenoid valves and/or thermo actuators, without being limited thereto.

The sump 70 may include a water collector 71, a seating portion 72, the drain 73, a drain pump coupler 75, and a soft water inlet 76. The water collector 71 may store water. The water collector 71 may store soft water supplied from the deionizer 200. The soft water inlet 76 may allow water to flow into the water collector 71. In addition, the water collector 71 may collect used water. The seating portion 72 may be coupled to the bottom 12b of the tub 12. The tub 12 and the sump 70 may be coupled by the seating portion 72. For example, a coupling protrusion 72a formed on the seating portion 72 may be coupled to bottom 12b. The water collected in the water collector 71 may be discharged through the drain 73. The drain pump 77 may be coupled to the drain pump coupler 75. Depending on an operation of the drain pump 77, the water collected in the water collector 71 may be discharged through the drain 73.

The bottommost portion of the case brake 100 may be in a higher position than the water collector 71 of the sump 70. Because potential energy of the water in the case brake 100 is greater than potential energy of water in the sump 70, the water collected in the sump 70 may not flow backward to the case brake 100.

The case brake 100 may include a case 110, a raw water inlet 151, a raw water outlet 152, a waste water inlet 153, and a waste water outlet 154. The raw water inlet 151, the raw water outlet 152, the waste water inlet 153, and the waste water outlet 154 may be referred to as a first inlet, a first outlet, a second inlet, and a second outlet, respectively.

The raw water inlet 151 may be connected to a water source S. Raw water may be introduced into the case brake 100 from the water source S through the raw water inlet 151. The raw water may be discharged through the raw water outlet 152. The raw water discharged from the raw water outlet 152 may be supplied to the deionizer 200 through a first flow path P1. The raw water may be introduced into an inlet 211 of the deionizer 200. The first flow path P1 may connect the raw water outlet 152 of the case brake 100 and the inlet 211 of the deionizer 200.

A first valve V1 may be provided on the first flow path P1. The first valve V1 may be referred to as a ‘raw water valve’. The first flow path P1 may be opened or closed by the first valve V1. Opening the first valve V1 may allow raw water to flow from the case brake 100 to the deionizer 200. Closing the first valve V1 may block the supply of raw water to the deionizer 200.

The soft water produced by the deionizer 200 may be supplied to the sump 70 through a second flow path P2. The second flow path P2 may connect an outlet 212 of the deionizer 200 and the soft water inlet 76 of the sump 70. The soft water may be discharged through the outlet 212 of the deionizer 200 and may flow into the soft water inlet 76 of the sump 70.

A second valve V2 may be provided on the second flow path P2. The second valve V2 may be referred to as a ‘soft water valve’. The second flow path P2 may be opened or closed by the second valve V2. Opening the second valve V2 may allow the soft water to flow from the deionizer 200 to the sump 70. Closing the second valve V2 may block the supply of the soft water to the sump 70.

The used water collected in the sump 70 may be discharged through the drain 73 of the sump 70. The drain 73 of the sump 70 may be referred to as a ‘used water drain’. The used water collected in the sump 70 may be discharged to the outside through a third flow path P3.

The third flow path P3 may connect the drain 73 of the sump 70 and the waste water inlet 153 of the case brake 100. The used water flowing into the waste water inlet 153 of the case brake 100 through the third flow path P3 may be discharged to the outside through the waste water outlet 154 of the case brake 100.

A third valve V3 may be provided on the third flow path P3. The third valve V3 may be referred to as a ‘drain valve’. The third flow path P3 may be opened or closed by the third valve V3. Opening the third valve V3 may allow the used water to flow from the sump 70 to the case brake 100. Closing the third valve V3 may block the flow of the used water to the case brake 100.

The used water may be supplied to the deionizer 200 for regeneration of the deionizer 200. The used water discharged from the sump 70 may be supplied to the deionizer 200 through a fourth flow path P4. The fourth flow path P4 may connect the first flow path P1 and the third flow path P3. An end of the fourth flow path P4 may be connected to the first flow path P1, and the other end of the fourth flow path P4 may be connected to the third flow path P3. The fourth flow path P4 may be coupled to the first flow path P1 and the third flow path P3, or may be formed integrally with the first flow path P1 and the third flow path P3.

In a case where the deionizer 200 is regenerated using used water, the used water may flow into the deionizer 200 from the sump 70 by sequentially passing through the third flow path P3, the fourth flow path P4, and the first flow path P1.

A fourth valve V4 may be provided on the fourth flow path P4. The fourth valve V4 may be referred to as a ‘reuse valve’. The fourth flow path P4 may be opened or closed by the fourth valve V4. Opening the fourth valve V4 may allow the used water to flow from the sump 70 to the deionizer 200. Closing the fourth valve V4 may block the flow of the used water to the deionizer 200.

In a case where the deionizer 200 is regenerated using raw water or used water, waste water discharged from the deionizer 200 may flow into the case brake 100 through a fifth flow path P5. The fifth flow path P5 may connect the second flow path P2 and the third flow path P3. One end of the fifth flow path P5 may be connected to the second flow path P2, and the other end of the fifth flow path P5 may be connected to the third flow path P3. The fifth flow path P5 may be coupled to the second flow path P2 and the third flow path P3, or may be formed integrally with the second flow path P2 and the third flow path P3.

During regeneration of the deionizer 200, the waste water discharged through the outlet 212 of the deionizer 200 may flow into the case brake 100 by sequentially passing through the second flow path P2, the fifth flow path P5, and the third flow path P3.

A fifth valve V5 may be provided on the fifth flow path P5. The fifth valve V5 may be referred to as a ‘waste water valve’. The fifth flow path P5 may be opened or closed by the fifth valve V5. Opening the fifth valve V5 may allow the waste water to flow from the deionizer 200 to the case brake 100 through the fifth flow path P5. Closing the fifth valve V5 may block the flow of waste water to the case brake 100.

A first branching point B1 where the third flow path P3 and the fourth flow path P4 are connected may be positioned closer to the drain 73 of the sump 70 than s second branching point B2 where the third flow path P3 and the fifth flow path P5 are connected. The third valve V3 may be positioned between the first branching point B1 and the second branching point B2. On the third flow path P3, the first branching point B1 may be positioned upstream, and the second branching point B2 may be positioned downstream.

Operation of each of the plurality of valves shown in FIG. 4 will be described in greater detail below.

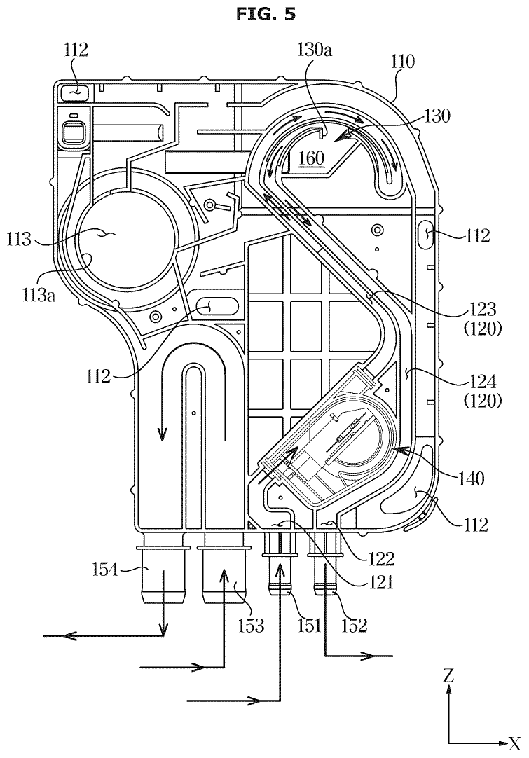

FIG. 5 is a cross-sectional view illustrating an inside of a case brake according to various embodiments.

Referring to FIG. 5, the case brake 100 may include the case 110, an internal flow path 120, an air brake 130, a flow sensor 140, the raw water inlet 151, the raw water outlet 152, the waste water inlet 153, and the waste water outlet 154.

The case brake 100 may include an external connection hole 112 and the tub connection hole 113. Air may flow between the outside of the dishwasher 1 and the inside of the case 110 through the external connection hole 112. The external connection hole 112 may be formed at various locations. For example, the external connection hole 112 may be formed at an upper part, a lower part, and a side of the case 110.

The tub connection hole 113 may correspond to the hole 12e of the tub 12. The case brake 100 may be coupled to the side 12d of the tub through a screw root (or screw thread) provided on an inside 113a of the tub connection hole and a screw root (or screw thread) formed on the inner side of the tub 12.

The case brake 100 may include an air brake chamber 160. The air brake chamber 160 may be formed in the case 110. The air brake chamber 160 may be connected to the air brake 130 and may receive water discharged from an air brake hole 130a.

The internal flow path 120 may be formed in the case 110. The internal flow path 120 may include an internal inlet 121 and an internal outlet 122. The internal flow path 120 may include a first internal flow path 123 and a second internal flow path 124. The first internal flow path 123 may guide raw water flowing into the case 110 through the raw water inlet 151 and the internal inlet 121 to the air brake 130. The raw water passing through the air brake 130 may pass through the second internal flow path 124, and then flow into the deionizer 200 through the internal outlet 122 and the raw water outlet 152.

The flow sensor 140 may be provided in the case 110 of the case brake 100. The flow sensor 140 may measure the amount of raw water flowing into the case brake 100 from the water source S per unit time (e.g., 1 second). The raw water flowing into the internal flow path 120 may sequentially pass through the flow sensor 140 and the air brake 130, and may be supplied to the deionizer 200 through the raw water outlet 152.

The raw water passing through the flow sensor 140 may flow into the air brake 130. The air brake 130 may prevent and/or reduce water from flowing back from the sump 70 to the case brake 100. The water passing through the internal flow path 120 may have the highest potential energy at the top of the air brake 130.

The used water discharged from the sump 70 or the waste water generated during the regeneration of the deionizer 200 may flow into the case brake 100 through the waste water inlet 153. The waste water inlet 153 may be connected to the drain 73 of the sump 70 through the third flow path P3. The used water or waste water introduced into the case brake 100 may be discharged to the outside of the dishwasher 1 through the waste water outlet 154.

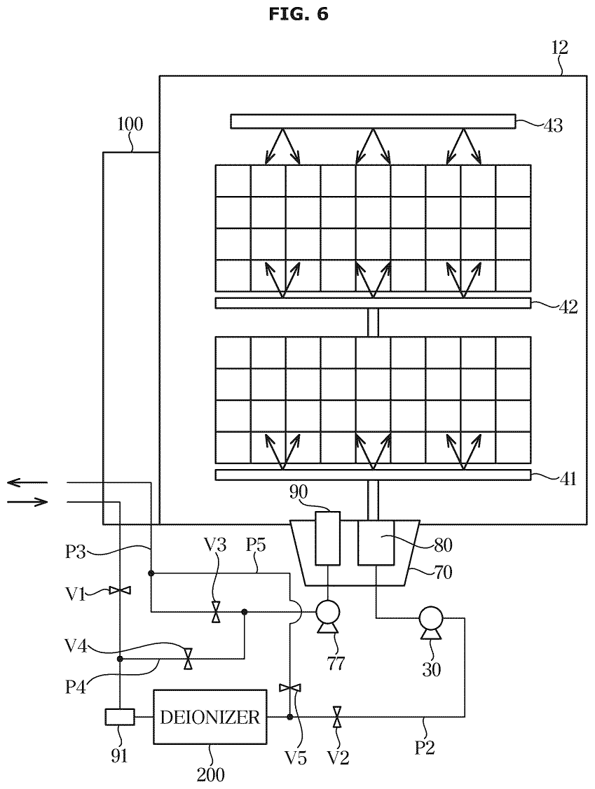

FIG. 6 is a diagram illustrating a dishwasher including various flow paths and valves according to various embodiments.

Referring to FIG. 6, the first flow path P1 may connect the case brake 100 and the deionizer 200. The first flow path P1 may guide raw water to the deionizer 200. The first flow path P1 may be provided with the first valve V1. The first valve V1 may open or close the first flow path P1 under the control of a controller 500.

The deionizer 200 may produce soft water by adsorbing ionic substances contained in the raw water. The soft water produced by the deionizer 200 may be supplied to the sump 70 through the second flow path P2. The second flow path P2 may be provided with the second valve V2. The second valve V2 may open or close the second flow path P2 under the control of the controller 500.

According to an operation of the circulation pump 30, the soft water may be stored in the sump 70, and the stored soft water may flow to the alternator 80. The water stored in the sump 70 by the alternator 80 may be sprayed through at least one of the first spraying unit 41, the second spraying unit 42, or the third spraying unit 43.

The soft water sprayed into the tub 12 may fall to the bottom 12b of the tub 12 together with the dirt on the dishes, and may be collected in the sump 70. The water collected in the sump 70 may be sprayed into the tub 12 again through the spraying units 41, 42, and 43 according to the operation of the circulation pump 30. The soft water used for dishwashing may be referred to as used water.

The used water collected in the sump 70 may move to the case brake 100 through the third flow path P3. The used water flowing into the case brake 100 may be discharged to the outside of the dishwasher 1. The third valve V3 may be provided on the third flow path P3. The third valve V3 may open or close the third flow path P3 under the control of the controller 500.

The fourth flow path P4 may connect the first flow path P1 and the third flow path P3.

One end of the fourth flow path P4 may be connected to the first flow path P1, and the other end of the fourth flow path P4 may be connected to the third flow path P3. The used water discharged from the sump 70 may be supplied to the deionizer 200 through the fourth flow path P4. The fourth valve V4 may be provided on the fourth flow path P4. The fourth valve V4 may open or close the fourth flow path P4 under the control of the controller 500.

The fifth flow path P5 may connect the second flow path P2 and the third flow path P3. One end of the fifth flow path P5 may be connected to the second flow path P2, and the other end of the fifth flow path P5 may be connected to the third flow path P3. The fifth flow path P5 may be provided with the fifth valve V5. The fifth valve V5 may open or close the fifth flow path P5 under the control of the controller 500.

On the first flow path P1, the first valve V1 may be positioned closer to the case brake 100 than the one end of the fourth flow path P4 connected to the first flow path P1. On the second flow path P2, the second valve V2 may be positioned closer to the sump 70 than the one end of the fifth flow path P5 connected to the second flow path P2. The third valve V3 may be positioned between the other end of the fourth flow path P4 connected to the third flow path P3 and the other end of the fifth flow path P5 connected to the third flow path P3.

The drain filter 90 may be mounted on the sump 70. The drain filter 90 may be connected to the drain 73 of the sump 70. The drain filter 90 may filter out impurities contained in the used water. A contamination level of the used water discharged from the sump 70 may be reduced by the drain filter 90.

A water purification filter 91 may be mounted on the inlet 211 of the deionizer 200. The water purification filter 91 may filter impurities contained in the raw water flowing into the deionizer 200 or may filter impurities contained in the used water flowing into the deionizer 200 through the fourth flow path P4. A contamination level of the raw water flowing into the deionizer 200 may be reduced by the water purification filter 91. In addition, a contamination level of the used water flowing into the deionizer 200 may be reduced by a first filtering of the used water by the drain filter 90 and a second filtering of the used water by the water purification filter 91.

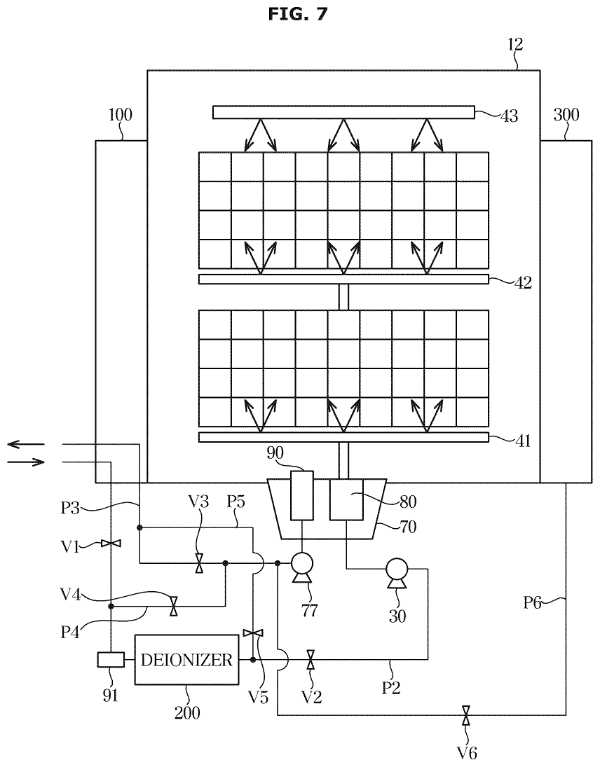

FIG. 7 is a diagram illustrating a dishwasher including various flow paths and valves according to various embodiments.

Referring to FIG. 7, the dishwasher 1 may further include a water tank 300. The water tank 300 may be coupled to an outer side of the tub 12. For example, the side of the tub 12 on which the water tank 300 is disposed may face the side 12d of the tub 12 on which the case brake 100 is disposed. For example, the case brake 100 and the water tank 300 may be disposed on one side and the other side of the tub 12, respectively, so as to face each other.

The dishwasher 1 may include a sixth flow path P6 connecting the third flow path P3 and the water tank 300. A sixth valve V6 may be provided on the sixth flow path P6. The sixth flow path P6 may be opened or closed by the sixth valve V6. The sixth valve V6 may open or close the sixth flow path P6 under the control of the controller 500. The sixth valve V6 may be referred to as a ‘water tank valve’.

The water tank 300 may store at least a portion of the used water collected in the sump 70 during a rinsing process. In a case where the sixth valve V6 is opened during a draining operation of the rinsing process, the used water discharged from the sump 70 may be stored in the water tank 300. The sixth valve V6 may be opened for a defined period of time during the draining operation of the rinsing process, and then closed. The used water stored in the water tank 300 may be used in a case where additional regeneration of the deionizer 200 is required after completion of the rinsing process.

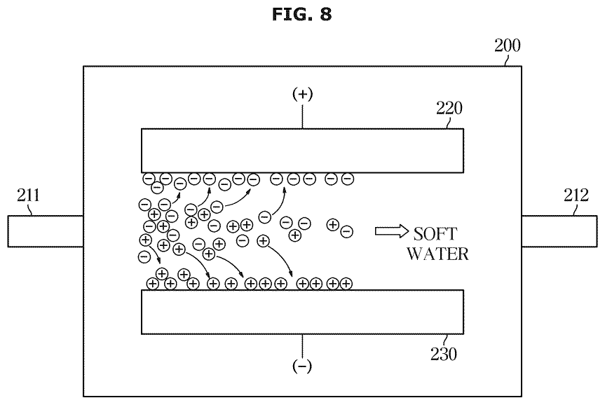

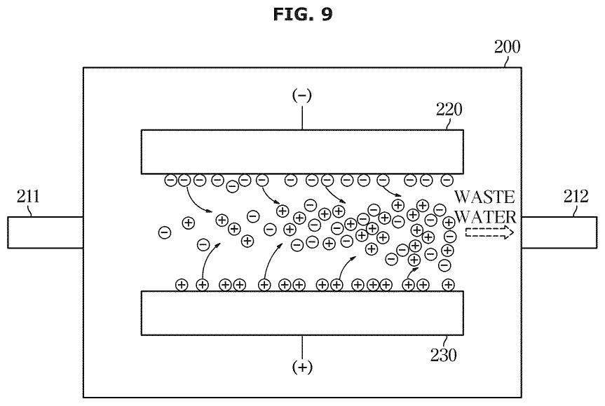

FIG. 8 is a diagram illustrating a principle of producing soft water by a deionizer according to various embodiments. FIG. 9 is a diagram illustrating a principle of regenerating a deionizer according to various embodiments.

Referring to FIG. 8 and FIG. 9, the deionizer 200 may include a plurality of electrodes 220 and 230. For example, the deionizer 200 may include the first electrode 220 and the second electrode 230. The first electrode 220 and the second electrode 230 may be arranged in parallel with a preset spacing. When a voltage is applied to the first electrode 220 and the second electrode 230, an electric field may be formed between the first electrode 220 and the second electrode 230. A direction of the electric field may vary depending on a polarity of the voltage applied to the first electrode 220 and the second electrode 230.

Referring to FIG. 8, an adsorption voltage may be applied to the first electrode 220 and the second electrode 230. For example, due to the application of adsorption voltage, the first electrode 220 may become an anode and the second electrode 230 may become a cathode. In this case, when water moves between the first electrode 220 and the second electrode 230 that are spaced apart from each other, ionic substances (e.g., dissolved solids) contained in the water may move towards the first electrode 220 and the second electrode 230 due to electrical attraction. An ionic substance with a negative charge may be adsorbed onto the first electrode 220, and an ionic substance with a positive charge may be adsorbed onto the second electrode 230. Accordingly, water passing through the deionizer 200 may become soft water that does not contain ionic substances or contains little ionic substances.

However, as the soft water is continuously produced and ionic substances continue to accumulate on the first electrode 220 and the second electrode 230, the electric field formed between the first electrode 220 and the second electrode 230 may become weak. The weak electric field may cause ionic substances not to be easily adsorbed onto the first electrode 220 and the second electrode 230, and thus an adsorption capacity of the deionizer 200 deteriorates. Regeneration of the deionizer 200 is required to restore the adsorption capacity of the deionizer 200.

Referring to FIG. 9, in order to restore the adsorption capacity of the deionizer 200, a regeneration voltage having a polarity opposite to the adsorption voltage may be applied to the first electrode 220 and the second electrode 230. Due to the application of the regeneration voltage, the first electrode 220 may become a cathode, and the second electrode 230 may become an anode. As the regeneration voltage having a polarity opposite to the adsorption voltage is applied to the first electrode 220 and the second electrode 230, the ionic substances attached to the first electrode 220 and the second electrode 230 may be separated from the first electrode 220 and the second electrode 230.

In addition, even in a case where no voltage is applied to the first electrode 220 and the second electrode 230, the ionic substances may be separated from the first electrode 220 and the second electrode 230. Because an attractive force acting on the ionic substances disappears when the electric field disappears, the ionic substances may be separated from the first electrode 220 and the second electrode 230. The ionic substances separated from the first electrode 220 and the second electrode 230 may be discharged to the outside together with water. Through the above, the adsorption capacity of the deionizer 200 may be restored.

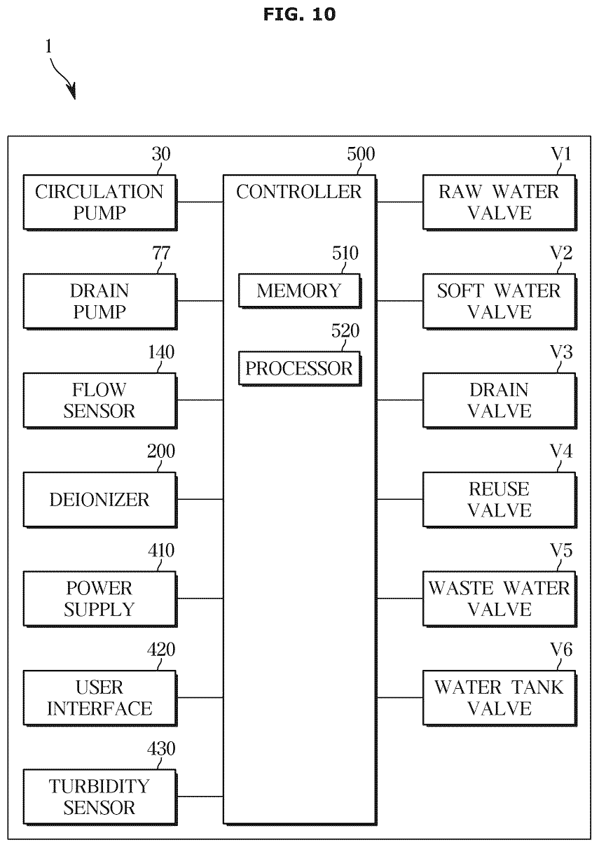

FIG. 10 is a block diagram illustrating an example configuration of a dishwasher according to various embodiments.

Referring to FIG. 10, the dishwasher 1 may include various components. The dishwasher 1 may include a controller (e.g., including at least one processor including various processing circuitry) 500. The controller 500 may be electrically connected to various components of the dishwasher 1 and may control the various components.

For example, the controller 500 may control the circulation pump 30, the drain pump 77, the flow sensor 140, and the deionizer 200. The controller 500 may control a power supply 410, a user interface (e.g., including various circuitry) 420, and a turbidity sensor 430. The controller 500 may control the raw water valve V1, the soft water valve V2, the drain valve V3, the reuse valve V4, and the waste water valve V5. In a case where the dishwasher 1 includes the water tank valve V6, the controller 500 may control the water tank valve V6.

The circulation pump 30 may transfer water stored in the sump 70 to the spraying units 41, 42, and 43. The water pumped by the circulation pump 30 may be sprayed into the tub 12 through at least one of the first spraying unit 41, the second spraying unit 42, or the third spraying unit 43. The controller 500 may operate or stop the circulation pump 30. The controller 500 may control a pressure of the water sprayed through the spraying units 41, 42, and 43 by controlling the circulation pump 30.

The drain pump 77 may transfer water collected in the water collector 71 of the sump 70 to the drain 73 of the sump 70. The controller 500 may operate or stop the drain pump 77. The controller 500 may operate the drain pump 77 to discharge used water during a draining operation of a washing process and a draining operation of a rinsing process.

The flow sensor 140 may measure the amount of raw water flowing into the case brake 100 from the water source S per unit time (e.g., 1 second). The amount of raw water flowing into the case brake 100 may correspond to the amount of raw water supplied to the deionizer 200.

The flow sensor 140 may transmit an electrical signal corresponding to the measured amount of raw water per unit time (e.g., 1 second) to the controller 500. The controller 500 may determine the cumulative amount of raw water supplied to the deionizer 200 based on the electrical signal transmitted from the flow sensor 140. The cumulative amount of raw water may correspond to the cumulative amount of soft water supplied from the deionizer 200 to the sump 70.

The deionizer 200 may produce soft water in the washing process and the rinsing process of the dishwasher 1. The deionizer 200 may produce soft water by adsorbing ionic substances contained in raw water. The controller 500 may control the deionizer 200 to produce soft water. The controller 500 may apply an adsorption voltage to the deionizer 200 to produce soft water. In addition, the deionizer 200 may generate waste water during regeneration of the deionizer 200.

The controller 500 may apply a regeneration voltage to the deionizer 200 for regeneration of the deionizer 200. The regeneration voltage may be opposite in polarity to the adsorption voltage.

The power supply 410 may be connected to an external power source and may obtain power required to operate the dishwasher 1. The power supply 410 may provide power to electronic components included in the dishwasher 1. The power supply 410 may include power circuitry and may be electrically connected to the controller 500. The controller 500 may control the power supply 410 and distribute power required for components of the dishwasher 1.

The user interface 420 may be provided on the door 20, without being limited thereto. The user interface 420 may be provided at various locations on the dishwasher 1.

The user interface 420 may include various interface circuitry, including, for example, a display and an inputter (e.g., including input circuitry). The display may display information about a state and/or operation of the dishwasher 1. The display may display information input by a user or information provided to the user on various screens. The display may display information related to an operation of the dishwasher 1 as at least one of an image or text. In addition, the display may display a Graphic User Interface (GUI) that enables control of the dishwasher 1. For example, the display may display a user interface element (UI element) such as an icon.

The display may include various types of display panels. For example, the display may include a liquid crystal display (LCD) panel, a light emitting diode (LED) panel, an organic LED (OLED) panel, or a micro LED panel. In addition, the display may be implemented as a touch display.

The inputter may include various circuitry and output an electrical signal (voltage or current) corresponding to a user input to the processor 520. The inputter may include various buttons and even a dial. In a case where the display is provided as a touch display, an inputter may not be provided. For example, the user interface 420 may obtain various user inputs, such as a user input for turning the dishwasher 1 on or off, and a user input for selecting a washing course.

The dishwasher 1 may provide various washing courses for washing dishes. For example, various washing courses, such as an automatic course, a standard course, an intensive course, a quick course, and/or a rinse-dry course, may be provided. The number and/or type of processes included in each washing course may be different. In addition, each washing course may include various washing options (e.g., washing time, temperature, etc.) that may be changed. A user may select a washing course using the user interface 420, and change various washing options that comprise the washing course. The dishwasher 1 may be operated according to the washing course and washing option set by the user input.

A washing course may include at least one process. When at least one process is performed, water may be sprayed to dishes placed in the dishwasher 1. For example, a standard course may include a pre-washing process, a main washing process, a rinsing process, a drying process, and a cooling process. The pre-washing process, the main washing process, the rinsing process, the drying process, and the cooling process may be performed sequentially. The rinse-dry course may include the rinsing process, the drying process, and the cooling process. The types of processes included in the washing course are not limited to the above.

The turbidity sensor 430 may detect a turbidity of water collected in the sump 70. Turbidity is a quantitative measure of the cloudiness of water, and represents a resistance to passage of light. The turbidity sensor 430 may be positioned in the sump 70. Various types of sensors may be used as the turbidity sensor 430. For example, the turbidity sensor 430 may emit pulsed light and detect light scattered from particles contained in water. The turbidity sensor 430 may determine the turbidity of water based on an intensity of the detected scattered light and/or the amount of the scattered light.

The turbidity of water may also be determined by the controller 500. The controller 500 may determine the turbidity of water based on an electrical signal transmitted from the turbidity sensor 430. The controller 500 may determine the regeneration of the deionizer 200 using used water, based on whether a turbidity of the used water is less than or equal to a defined threshold value.

The controller 500 may be positioned in the main body 10. The controller 500 may include a memory 510 and a processor 520.

The memory 510 may record/store various information required for operation of the dishwasher 1. The memory 510 may store instructions, an application, data and/or a program required for operation of the dishwasher 1. For example, the memory 510 may include a volatile memory for temporarily storing data, such as a Static Random Access Memory (SRAM), or a Dynamic Random Access Memory (DRAM). The memory 510 may also include a non-volatile memory for storing data for a long time, such as a Read-Only Memory (ROM), an Erasable Programmable ROM (EPROM), or an Electrically Erasable Programmable ROM (EEPROM).

The processor 520 may generate control signals for controlling operation of the dishwasher 1 based on the instructions, application, data and/or program stored in the memory 510. The processor 520 may include logic circuitry and operation circuitry in hardware. The processor 520 may process data according to the program and/or instructions provided from the memory 510, and generate a control signal based on the processing result. The memory 510 and the processor 520 may be implemented in a single control circuit or in a plurality of circuits. The processor 520 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The controller 500 may open or close the raw water valve V1 positioned on the first flow path P1 for supplying raw water to the deionizer 200. The controller 500 may open or close the soft water valve V2 positioned on the second flow path P2 for supplying soft water to the sump 70. The controller 500 may open or close the drain valve V3 positioned on the third flow path P3 for draining the used water collected in the sump 70 to the outside.

The controller 500 may open or close the reuse valve V4 positioned on the fourth flow path P4 for supplying the used water to the deionizer 200. The controller 500 may open or close the waste water valve V5 positioned on the fifth flow path P5 for discharging waste water generated during regeneration of the deionizer 200 to the outside. The controller 500 may open or close the water tank valve V6 positioned on the sixth flow path P6 connected to the water tank 300. In addition, the controller 500 may adjust an opening degree of each of the raw water valve V1, the soft water valve V2, the drain valve V3, the reuse valve V4, the waste water valve V5, and the water tank valve V6.

Controllable components included in the dishwasher 1 are not limited to those illustrated. In addition to those illustrated in FIG. 10, the dishwasher 1 may include other controllable components, or some of the components described above may be omitted.

For example, the dishwasher 1 may include a heater for heating water supplied to the tub 12 and a heater for heating air supplied to the tub 12. The dishwasher 1 may include a fan for supplying air to the tub 12. Operation of the heater and the may cause hot air to be supplied to the tub 12.

In addition, the dishwasher 1 may further include a communication interface. The communication interface may include various communication circuitry including, for example, a wired communication module and/or a wireless communication module for communicating with an external device (e.g., a mobile device, a computer, etc.). The wired communication module may communicate with the external device through a wide area network such as the Internet, and the wireless communication module may communicate with the external device through an access point connected to the wide area network. A user may remotely control the dishwasher 1 using the external device.

Although it has been described that the dishwasher 1 is controlled by the controller 500, the dishwasher 1 may also be controlled by the processor 520.

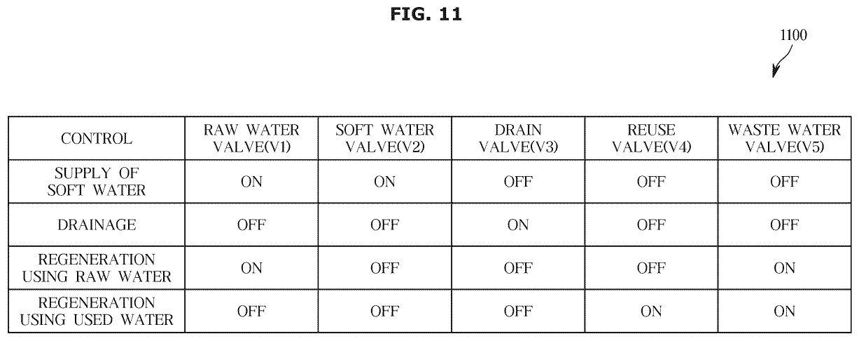

FIG. 11 is a table 1100 illustrating example operations of valves included in a dishwasher according to various embodiments. Referring to the table 1100 of FIG. 11, a plurality of valves may be controlled in response to various operations of the dishwasher 1. In the table 1100, ‘ON’ indicates an opening of each valve, and ‘OFF’ indicates a closing of each valve.

The controller 500 of the dishwasher 1 may open the first valve V1 and the second valve V2 and close the third valve V3, the fourth valve V4, and the fifth valve V5 to supply soft water to the tub 12. The supply of soft water may be performed at a start of a washing process and at a start of a rinsing process. The controller 500 may close the second valve V2 and open the fifth valve V5, based on a defined amount of soft water being stored in the tub 12. The controller 500 may identify the amount of soft water stored in the tub 12 based on a signal transmitted from the flow sensor 140.

The controller 500 may open the third valve V3 and close the first valve V1, the second valve V2, the fourth valve V4, and the fifth valve V5 to discharge the used water collected in the sump 70 to the outside of the dishwasher 1. During a draining operation of the washing process and a draining operation of the rinsing process, the used water may be discharged to the outside of the dishwasher 1.

The controller 500 may control the plurality of valves to allow the deionizer 200 to be regenerated using raw water or used water, in at least one of the washing process or the rinsing process.

The controller 500 may control the plurality of valves to allow the deionizer 200 to be regenerated using the raw water, while the soft water stored in the sump 70 is sprayed into the tub 12, in at least one of the washing process or the rinsing process. The controller 500 may close the second valve V2, the third valve V3, and the fourth valve V4, and open the first valve V1 and the fifth valve V5 to allow the deionizer 200 to be regenerated using the raw water.

The controller 500 may close the first valve V1, the second valve V2, and the third valve V3, and open the fourth valve V4 and the fifth valve V5 to allow the deionizer 200 to be regenerated using the used water, in at least one of the washing process or the rinsing process. The regeneration of the deionizer 200 using the used water may be performed during at least one of the draining operation of the washing process or the draining operation of the rinsing process.

In a case where a plurality of rinsing processes are performed, the regeneration of the deionizer 200 using the used water may be performed for each of the plurality of rinsing processes or may be performed in the last rinsing process.

The regeneration of the deionizer 200 may be performed only when needed. The controller 500 may identify whether the regeneration of the deionizer 200 is required. For example, in a case where the cumulative amount of raw water supplied to the deionizer 200 reaches a defined limit value, the controller 500 may determine that regeneration of the deionizer 200 is required. In a case where the accumulated number of times the washing process and the rinsing process are performed reaches a defined threshold number of times, the controller 500 may determine that regeneration of the deionizer 200 is required. In a case where the accumulated usage time of the dishwasher 1 reaches a defined threshold time, the controller 500 may determine that regeneration of the deionizer 200 is required.

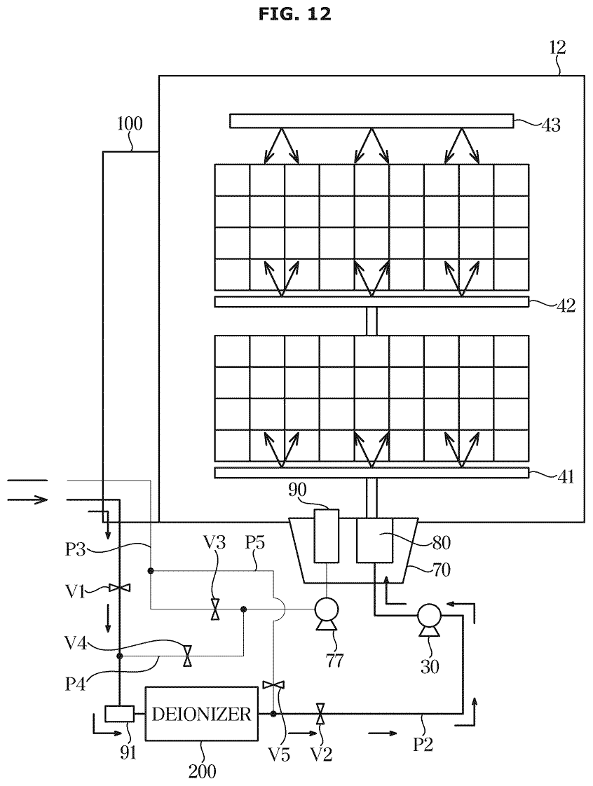

FIG. 12 is a diagram illustrating a soft water path for supplying soft water to a sump in a washing process and a rinsing process according to various embodiments.

Referring to FIG. 11 and FIG. 12, the controller 500 of the dishwasher 1 may open the first valve V1 and the second valve V2 and close the third valve V3, the fourth valve V4, and the fifth valve V5 to supply soft water to the tub 12 at a start of a washing process and at a start of a rinsing process.

Opening the first valve V1 may allow raw water to flow into the deionizer 200 through the first flow path P1. In addition, opening the second valve V2 may allow soft water produced by the deionizer 200 to flow into the sump 70 through the second flow path P2. Closing the fourth valve V4 may block raw water from flowing into the fourth flow path P4. Closing the fifth valve V5 may block soft water from flowing into the fifth flow path P5.

The controller 500 may close the second valve V2 and open the fifth valve V5 based on a defined amount of soft water being stored in the tub 12. The soft water stored in the sump 70 may be supplied to at least one of the first spraying unit 41, the second spraying unit 42, or the third spraying unit 43 through the alternator 80. For example, in a case where the defined amount of soft water is stored in the sump 70 and the tub 12, the production of soft water may be stopped, and the soft water may be sprayed into the tub 12 through the spraying units 41, 42, and 43.

The sprayed soft water may wash dishes and be collected again in the sump 70 together with the dirt (impurities). The soft water used for washing dishes may be referred to as used water, and the used water may be sprayed again through the spraying units 41, 42, and 43. For example, water may circulate in the tub 12. The circulation of the water in the tub 12 may be performed for a defined spraying time (spraying operation).

In a case where the spraying operation of spraying water (including soft water and used water) into the tub 12 for the defined spraying time in the washing process and rinsing process is completed, a draining operation may be entered.

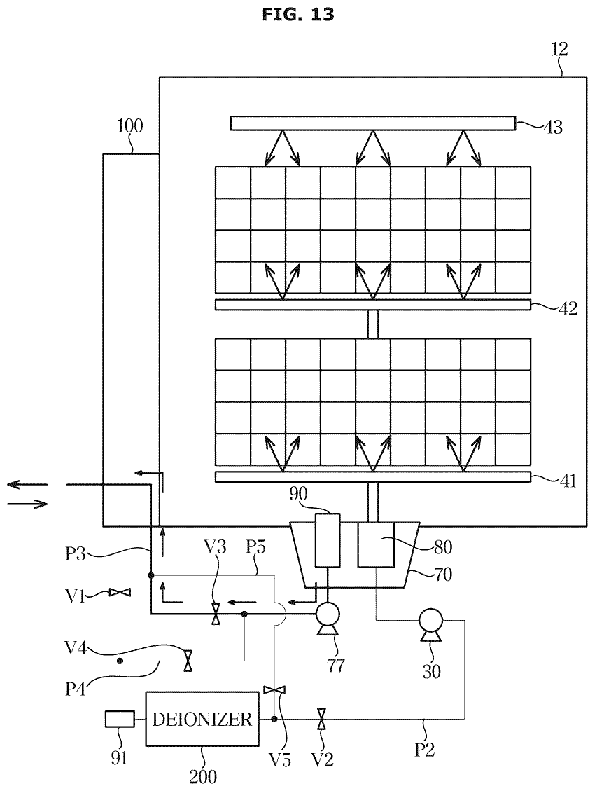

FIG. 13 is a diagram illustrating a drainage path for discharging used water to an outside in a washing process and a rinsing process according to various embodiments.

Referring to FIG. 13, based on completion of a spraying operation in each of a washing process and a rinsing process, a draining operation may be entered. In a case where regeneration of the deionizer 200 is not performed during the draining operation of the washing process and the draining operation of the rinsing process, used water collected in the sump 70 may be discharged to the outside of the dishwasher 1 through the case brake 100. For example, in a case where the regeneration of the deionizer 200 using the used water is omitted, the used water may be discharged to the outside of the dishwasher 1.

As described in FIG. 11, the controller 500 may open the third valve V3 and close the first valve V1, the second valve V2, the fourth valve V4, and the fifth valve V5 to discharge the used water collected in the sump 70 to the outside of the dishwasher 1. Because only the third valve V3 is open, the used water collected in the sump 70 may flow to the case brake 100 through the third flow path P3 and does not flow into the other flow paths.

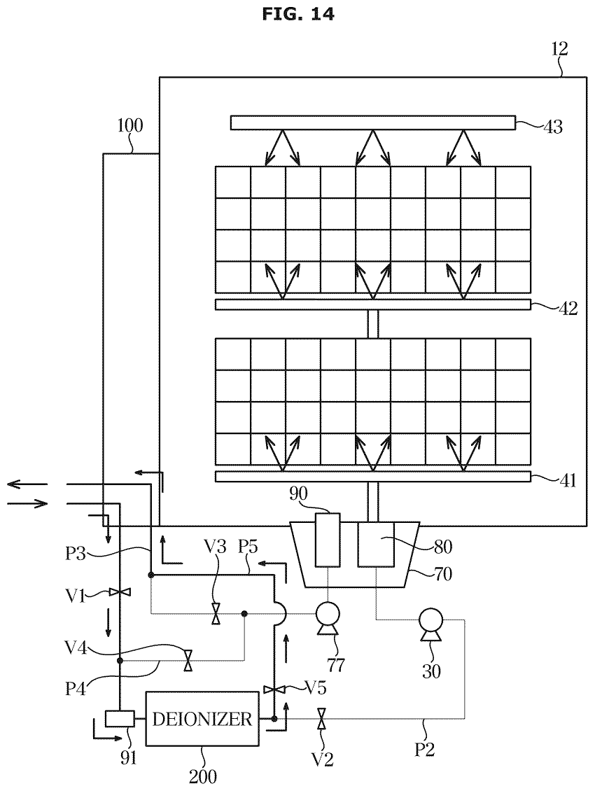

FIG. 14 is a diagram illustrating a flow path used for regenerating a deionizer using raw water according to various embodiments.

Referring to FIG. 11 and FIG. 14, the dishwasher 1 may regenerate the deionizer 200 using raw water, while soft water stored in the sump 70 is sprayed into the tub 12, in at least one of a washing process or a rinsing process. To regenerate the deionizer 200 using raw water, the controller 500 may close the second valve V2, the third valve V3, and the fourth valve V4, and open the first valve V1 and the fifth valve V5.

In this case, the raw water discharged from the case brake 100 may flow into the deionizer 200 through the first flow path P1. The deionizer 200 may be regenerated by the raw water and discharge waste water. The waste water discharged from the deionizer 200 may flow into the case brake 100 through a part of the second flow path P2 and the fifth flow path P5 and the third flow path P3.

Because the second valve V2 is closed, the waste water may not be supplied to the sump 70 through the second flow path P2. Because the fourth valve V4 is closed, the raw water may not be introduced into the sump 70 through the fourth flow path P4. Because the third valve V3 is closed, the waste water may not be introduced into the sump 70 through the third flow path P3. For example, a backflow of the waste water may be blocked. In addition, the used water collected in the sump 70 may not be discharged.

As such, the regeneration of the deionizer 200 using the raw water may be performed simultaneously with the washing or rinsing of the dishes. Because no separate time is required for regeneration of the deionizer 200, the dishwasher 1 may be used continuously.

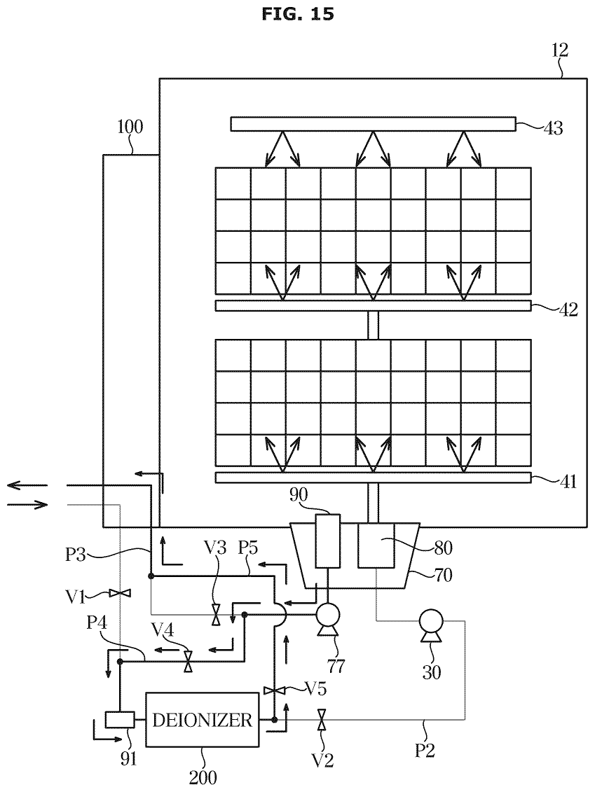

FIG. 15 is a diagram illustrating a flow path used for regenerating a deionizer using used water according to various embodiments.

Referring to FIG. 11 and FIG. 15, the dishwasher 1 may regenerate the deionizer 200 using used water, during at least one of a draining operation of a washing process or a draining operation of a rinsing process. In order to regenerate the deionizer 200 using the used water, the controller 500 may close the first valve V1, the second valve V2, and the third valve V3, and open the fourth valve V4 and the fifth valve V5.

Because the third valve V3 is closed and the fourth valve V4 is opened, the used water discharged from the sump 70 may flow into the deionizer 200 through the fourth flow path P4. Because the first valve V1 is closed, the raw water may not be supplied to the deionizer 200, and the used water may not flow to the case brake 100 through the first flow path P1.

The deionizer 200 may be regenerated by the used water and discharge waste water. The waste water may flow to the case brake 100 through the second flow path P2, the fifth flow path P5, and the third flow path P3. Because the second valve V2 is closed, the waste water discharged from the deionizer 200 may not flow to the sump 70 through the second flow path P2.

Using the used water for the regeneration of the deionizer 200, use of raw water may be reduced. Because the deionizer 200 may be regenerated during the draining operation of the washing process and the draining operation of the rinsing process, no separate time is required for regeneration of the deionizer 200, and the dishwasher 1 may be used continuously.

In addition, because a regeneration efficiency of the deionizer 200 is higher in a case where soft water is used than in a case where raw water is used, the regeneration efficiency of the deionizer 200 may be increased using the used water corresponding to the soft water.

In addition, as described in FIG. 14 and FIG. 15, the dishwasher 1 according to the disclosure may regenerate the deionizer 200 using the raw water supplied from a water source or water used for dishwashing without a separate water tank. Accordingly, the dishwasher 1 may be made more compact.

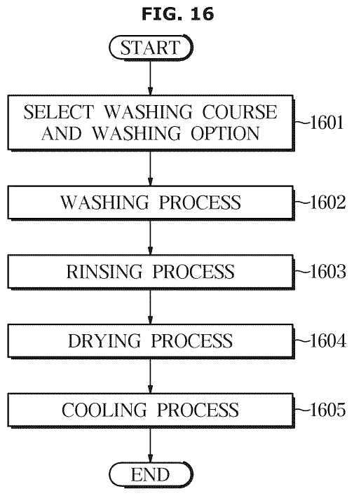

FIG. 16 is a flowchart illustrating an example process performed by a dishwasher to wash dishes according to various embodiments.

Referring to FIG. 16, the controller 500 of the dishwasher 1 may identify a selection of a washing course and a selection of a washing option (1601). A user may select the washing course and the washing option using the user interface 420 or an external device. In general, the washing course may include a washing process, a rinsing process, a drying process, and a cooling process. The washing option may include detailed settings for each of the washing process, the rinsing process, the drying process, and the cooling process. The controller 500 may control an operation of the dishwasher 1 according to the selected washing course and washing option. The washing process, the rinsing process, the drying process, and the cooling process may be performed sequentially.

The dishwasher 1 may perform the washing process (1602). The washing process may include a water supply operation, a spraying operation, and a draining operation. In the water supply operation of the washing process, a defined amount of soft water may be stored in the sump 70 and the tub 12. In the spraying operation of the washing process, the soft water stored in the sump 70 and the tub 12 may be sprayed into the tub 12 through the spraying units 41, 42, and 43 for a defined spraying time. In the draining operation of the washing process, the soft water used for dishwashing may be discharged to the outside of the dishwasher 1.

The washing process may include a pre-washing process and a main washing process. Each of the pre-washing process and the main washing process may include a water supply operation, a spraying operation, and a draining operation.

The dishwasher 1 may perform the rinsing process (1603). The rinsing process may also include a water supply operation, a spraying operation, and a draining operation. In the water supply operation of the rinsing process, a defined amount of soft water may be stored in the sump 70 and the tub 12. In the spraying operation of the rinsing process, the soft water stored in the sump 70 and the tub 12 may be sprayed into the tub 12 through the spraying units 41, 42, and 43 for a defined spraying time. In the draining operation of the rinsing process, the soft water used for dishwashing may be discharged to the outside of the dishwasher 1. The rinsing process may be performed multiple times.

The dishwasher 1 may perform the drying process (1604). In the drying process, hot air may be supplied into the tub 12. The hot air may circulate inside the tub 12 and evaporate moisture remaining on the dishes.

The dishwasher 1 may perform the cooling process (1605). In the cooling process, air at a relatively low temperature may be supplied to the tub 12. In the cooling process, a temperature of the dishes may be reduced.

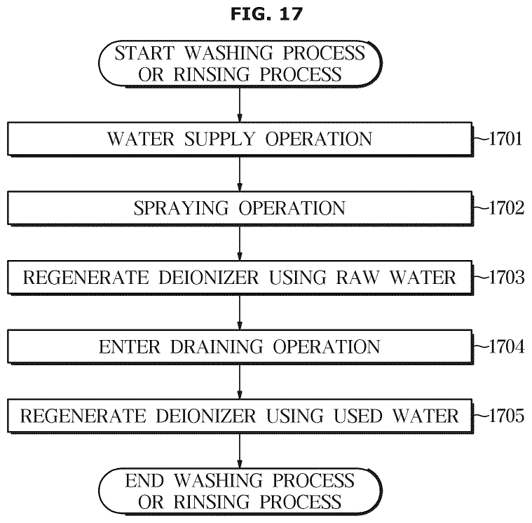

FIG. 17 is a flowchart illustrating an example method for controlling the dishwasher performed to regenerate the deionizer in the washing process and the rinsing process illustrated in FIG. 16 according to various embodiments.

Referring to FIG. 17, the washing process and the rinsing process of the dishwasher 1 may each include the water supply operation, the spraying operation, and the draining operation. At a start of the washing process or the rinsing process of the dishwasher 1, the water supply operation may be entered (1701). Soft water may be supplied to the sump 70 and the tub 12 in the water supply operation.

In order to supply soft water to the sump 70 and the tub 12, the controller 500 may control the deionizer 200 and the plurality of valves. For example, the controller 500 may apply an adsorption voltage to the deionizer 200, open the first valve V1 and the second valve V2, and close the third valve V3, the fourth valve V4, and the fifth valve V5. In a case where a defined amount of soft water is stored in the tub 12, the water supply operation may be completed.

Based on completion of the water supply operation, the dishwasher 1 may enter the spraying operation (1702). In the spraying operation, the soft water stored in the sump 70 and the tub 12 may be sprayed into the tub 12 through the spraying units 41, 42, and 43 for a defined spraying time.

While the soft water stored in the sump 70 is sprayed into the tub 12, the dishwasher 1 may regenerate the deionizer 200 using the raw water (1703). In order to regenerate the deionizer 200 using the raw water during the spraying operation, the controller 500 may apply a regeneration voltage to the deionizer 200, close the second valve V2, the third valve V3, and the fourth valve V4, and open the first valve V1 and the fifth valve V5.

Based on completion of the spraying operation, the dishwasher 1 may enter the draining operation (1704). In the draining operation, the soft water used for dishwashing may be discharged to the outside of the dishwasher 1. In the draining operation, the dishwasher 1 may regenerate the deionizer 200 using the used water (1705). In order to regenerate the deionizer 200 using the used water during the draining operation, the controller 500 may apply a regeneration voltage to the deionizer 200, close the first valve V1, the second valve V2, and the third valve V3, and open the fourth valve V4 and the fifth valve V5.

Based on completion of the draining operation, the dishwasher 1 may complete the washing process or the rinsing process.

In a case where regeneration of the deionizer 200 is not required, at least one of the regeneration of the deionizer 200 using raw water or the regeneration of the deionizer 200 using used water may be omitted.

Whether regeneration of the deionizer 200 is required may be determined by various methods. For example, the controller 500 may determine that regeneration of the deionizer 200 is required, in a case where the cumulative amount of raw water supplied to the deionizer 200 reaches a defined limit value. The controller 500 may determine that regeneration of the deionizer 200 is required in a case where the accumulated number of times the washing process and the rinsing process are performed reaches a defined threshold number of times. The controller 500 may determine that regeneration of the deionizer 200 is required in a case where the accumulated usage time of the dishwasher 1 reaches a defined threshold time.

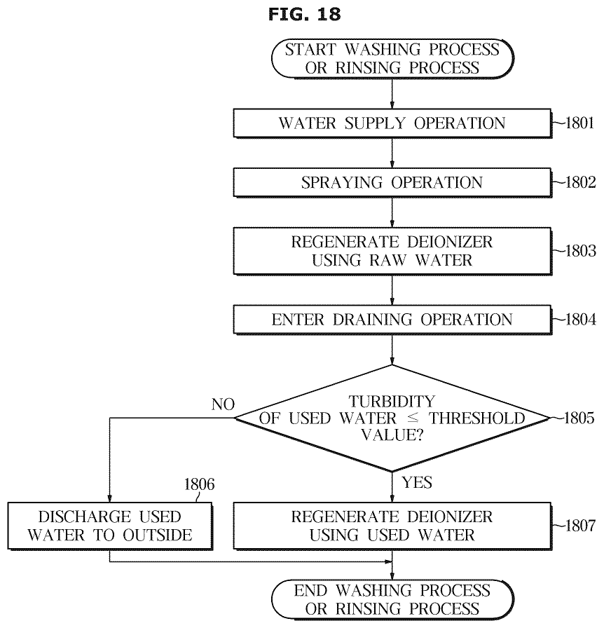

FIG. 18 is a flowchart illustrating an example method for controlling the dishwasher illustrated in FIG. 17 according to various embodiments.

Referring to FIG. 18, at a start of the washing process or the rinsing process of the dishwasher 1, the water supply operation may be entered (1801). In the water supply operation, soft water may be supplied to the sump 70 and the tub 12. Based on completion of the water supply operation, the dishwasher 1 may enter the spraying operation (1802). In the spraying operation, soft water stored in the sump 70 and the tub 12 may be sprayed into the tub 12 through the spraying units 41, 42, and 43 for a defined spraying time.

While the soft water stored in the sump 70 is sprayed into the tub 12, the dishwasher 1 may regenerate the deionizer 200 using raw water (1803). In order to regenerate the deionizer 200 using raw water during the spraying operation, the controller 500 may apply a regeneration voltage to the deionizer 200, close the second valve V2, the third valve V3, and the fourth valve V4, and open the first valve V1 and the fifth valve V5.

Based on completion of the spraying operation, the dishwasher 1 may enter the draining operation (1804). In the draining operation, the controller 500 of the dishwasher 1 may compare a turbidity of water (e.g., the used water) with a defined threshold value (1805), based on an electrical signal transmitted from the turbidity sensor 430.

The controller 500 may control the plurality of valves to allow the used water to be discharged outside the dishwasher 1 based on the turbidity of the used water being greater than the threshold value (1806). For example, the controller 500 may open the third valve V3 and close the first valve V1, the second valve V2, the fourth valve V4, and the fifth valve V5 to discharge the used water to the outside. Because a significantly high turbidity of the used water may rather contaminate the deionizer 200, it is preferable to discharge the used water to the outside.

In a case where the turbidity of the used water is less than or equal to the threshold value, the controller 500 may regenerate the deionizer 200 using the used water (1807). In order to regenerate the deionizer 200 using the used water, the controller 500 may close the first valve V1, the second valve V2, and the third valve V3, and open the fourth valve V4 and the fifth valve V5.

Based on completion of the draining operation, the dishwasher 1 may end the washing process or the rinsing process.

As described above, in a case where regeneration of the deionizer 200 is not required, at least one of the regeneration of the deionizer 200 using raw water or the regeneration of the deionizer 200 using used water may be omitted.

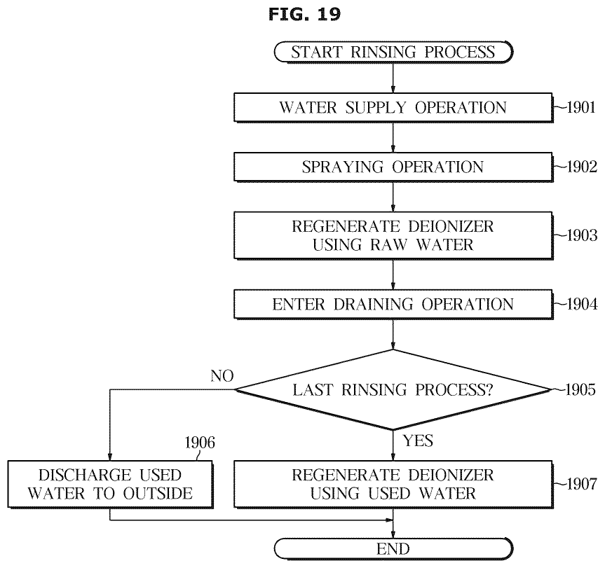

FIG. 19 is a flowchart illustrating an example method for controlling the dishwasher performed to regenerate the deionizer in the rinsing process illustrated in FIG. 16 according to various embodiments.

Referring to FIG. 19, at a start of the washing process or the rinsing process of the dishwasher 1, the water supply operation may be entered (1901). In the water supply operation, soft water may be supplied to the sump 70 and the tub 12. Based on completion of the water supply operation, the dishwasher 1 may enter the spraying operation (1902). In the spraying operation, soft water stored in the sump 70 and the tub 12 may be sprayed into the tub 12 through the spraying units 41, 42, and 43 for a defined spraying time.

While the soft water stored in the sump 70 is sprayed into the tub 12, the dishwasher 1 may regenerate the deionizer 200 using raw water (1903). In order to regenerate the deionizer 200 using raw water during the spraying operation, the controller 500 may apply a regeneration voltage to the deionizer 200, close the second valve V2, the third valve V3, and the fourth valve V4, and open the first valve V1 and the fifth valve V5.

Based on completion of the spraying operation, the dishwasher 1 may enter the draining operation (1904). The controller 500 may identify whether a current rinsing process is a last rinsing process of the plurality of rinsing processes (1905).

In a case where the current rinsing process is not the last rinsing process, the controller 500 may control the plurality of valves to allow the used water to be discharged to the outside of the dishwasher 1 (1906). For example, the controller 500 may open the third valve V3, and close the first valve V1, the second valve V2, the fourth valve V4, and the fifth valve V5, to discharge the used water to the outside.

In a case where the current rinsing process is the last rinsing process, the controller 500 may regenerate the deionizer 200 using the used water (1907). To regenerate the deionizer 200 using the used water, the controller 500 may close the first valve V1, the second valve V2, and the third valve V3, and open the fourth valve V4 and the fifth valve V5. In a case where the rinsing process is performed multiple times, a contamination level of the used water may be the lowest in the last rinsing process. Accordingly, by regenerating the deionizer 200 using the used water in the last rinsing process, contamination of the deionizer 200 may be minimized and/or reduced.

According to an embodiment, in a case where the dishwasher 1 includes the water tank 300, the controller 500 may open the sixth valve V6 for a defined time and then close the sixth valve V6 to allow the used water to be stored in the water tank 300 during the draining operation of each rinsing process while the plurality of rinsing processes are performed. The controller 500 may additionally regenerate the deionizer 200 after completion of the last rinsing process of the plurality of rinsing processes. The controller 500 may open the sixth valve V6 to allow the deionizer 200 to be additionally regenerated using the used water stored in the water tank 300 after the completion of the last rinsing process. In this case, as in a general draining operation, the controller 500 may open the third valve V3 and close the first valve V1, the second valve V2, the fourth valve V4, and the fifth valve V5.

According to an example embodiment of the disclosure, a dishwasher may include: a cabinet; a tub disposed in the cabinet; a sump disposed below the tub; a deionizer configured to produce soft water using raw water supplied from a water source, and to supply the soft water to the sump; a plurality of flow paths comprising a pipe and/or a hose configured to allow the raw water, the soft water, and used water collected in the sump to flow; a plurality of valves disposed in each of the plurality of flow paths; and a controller including at least one processor, comprising processing circuitry, individually and/or collectively, configured to control the plurality of valves to allow the deionizer to be regenerated using the raw water or the used water, in at least one of a washing process or a rinsing process.

The plurality of valves may include: a first valve configured to open or close a first flow path configured to supply the raw water to the deionizer; a second valve configured to open or close a second flow path configured to supply the soft water produced by the deionizer to the sump; a third valve configured to open or close a third flow path configured to drain the used water collected in the sump to an outside; a fourth valve configured to open or close a fourth flow path configured to supply the used water to the deionizer; and a fifth valve configured to open or close a fifth flow path configured to connect the second flow path and the third flow path.

The controller may be configured to close the second valve, the third valve, and the fourth valve, and open the first valve and the fifth valve, so as to regenerate the deionizer using the raw water, in at least one of the washing process or the rinsing process.

The controller may be configured to control the plurality of valves to allow the deionizer to be regenerated using the raw water, while the soft water stored in the sump is sprayed into the tub, in at least one of the washing process or the rinsing process.

The controller may be configured to: open the first valve and the second valve and close the third valve, the fourth valve and the fifth valve to supply the soft water to the tub at a start of the washing process and a start of the rinsing process, and close the second valve and open the fifth valve based on a defined amount of the soft water being stored in the tub.

The controller may be configured to close the first valve, the second valve, and the third valve, and open the fourth valve and the fifth valve, to allow the deionizer to be regenerated using the used water, in at least one of the washing process or the rinsing process.

The controller may be configured to control the plurality of valves to allow the deionizer to be regenerated using the used water, during at least one of a draining operation of the washing process or a draining operation of the rinsing process.

The controller may be configured to control the plurality of valves to allow the deionizer to be regenerated using the used water, in a last rinsing process of a plurality of rinsing processes.

The dishwasher may further include a turbidity sensor configured to detect a turbidity of the used water. The controller may be configured to determine regeneration of the deionizer using the used water, based on the turbidity of the used water being less than or equal to a defined threshold value.

One end of the fourth flow path may be connected to the first flow path, and another end of the fourth flow path may be connected to the third flow path. A first branching point where the third flow path and the fourth flow path are connected may be located closer to a drain of the sump than a second branching point where the third flow path and the fifth flow path are connected. The third valve may be located between the first branching point and the second branching point.

The dishwasher may further include: a water tank; and a sixth valve configured to open or close a sixth flow path configured to connect the third flow path and the water tank.

The controller may be configured to close the sixth valve after opening the sixth valve for a defined time to allow the used water to be stored in the water tank while a plurality of rinsing processes are performed. The controller may be configured to open the sixth valve to allow the deionizer to be additionally regenerated using the used water stored in the water tank, so as to additionally regenerate the deionizer after completion of a last rinsing process of the plurality of rinsing processes.

The dishwasher may further include a drain filter connected to a drain of the sump.

The dishwasher may further include a water purification filter connected to an inlet of the deionizer.

According to an example embodiment of the disclosure, in a method for controlling a dishwasher including a tub, a sump disposed below the tub, a deionizer configured to produce soft water using raw water supplied from a water source and supply the soft water to the sump, a plurality of flow paths comprising at least one pipe and/or at least one hose configured to allow the raw water, the soft water, and used water collected in the sump to flow, and a controller including at least one processor, comprising processing circuitry, the method may include: supplying the soft water to the sump by controlling the deionizer and a plurality of valves arranged on the plurality of flow paths by the controller in a washing process and a rinsing process, to wash dishes placed in the tub; and performing regeneration of the deionizer using the raw water and/or the used water in at least one of the washing process or the rinsing process, by controlling the plurality of valves by the controller.

The performing of regeneration of the deionizer using the raw water may include: opening a first valve to open a first flow path configured to supply the raw water to the deionizer; closing a second valve to close a second flow path configured to supply the soft water produced by the deionizer to the sump; closing a third valve to close a third flow path configured to drain the used water collected in the sump to an outside; closing a fourth valve to close a fourth flow path configured to supply the used water to the deionizer; and opening a fifth valve to open a fifth flow path configured to connect the second flow path and the third flow path.

The performing of regeneration of the deionizer using the raw water may be performed while the soft water stored in the sump is sprayed into the tub, in at least one of the washing process or the rinsing process.

The supplying of the soft water to the sump may include: opening the first valve and the second valve and closing the third valve, the fourth valve and the fifth valve at a start of the washing process and a start of the rinsing process; and closing the second valve and opening the fifth valve based on a defined amount of the soft water being stored in the tub.

The performing of regeneration of the deionizer using the used water may include: closing a first valve to close a first flow path configured to supply the raw water to the deionizer; closing a second valve to close a second flow path configured to supply the soft water produced by the deionizer to the sump; closing a third valve to close a third flow path configured to drain the used water collected in the sump to an outside; opening a fourth valve to open a fourth flow path configured to supply the used water to the deionizer; and opening a fifth valve to open a fifth flow path configured to connect the second flow path and the third flow path.

The performing of regeneration of the deionizer using the used water may be performed in at least one of a draining operation of the washing process or a draining operation of the rinsing process.

The performing of regeneration of the deionizer using the used water may be performed in a last rinsing process of a plurality of rinsing processes.

According to the disclosure, the dishwasher and the method for controlling the same may regenerate the deionizer using raw water supplied from a water source or water used for dishwashing without a separate water tank. Accordingly, the dishwasher may have a relatively compact structure, and may be easily managed hygienically by not including the water tank. In addition, using the water used for dishwashing to regenerate the deionizer, the use of raw water may be reduced.

According to the disclosure, the dishwasher and the method for controlling the same may regenerate the deionizer while a washing course for dishwashing is performed. Because dishwashing and the deionizer regeneration may be performed simultaneously, no additional time is required to regenerate the deionizer, and user convenience may be improved.

The various example embodiments may be implemented in the form of a recording medium that stores instructions executable by a computer. The instructions may be stored in the form of program codes, and when executed by a processor, the instructions may create a program module to perform operations of the disclosed embodiments.

The machine-readable recording medium may be provided in the form of a non-transitory storage medium, wherein the ‘non-transitory storage medium’ is a tangible device, and may not include a signal (e.g., an electromagnetic wave), but this term does not differentiate between where data is semi-permanently stored in the storage medium and where the data is temporarily stored in the storage medium. For example, a ‘non-transitory storage medium’ may include a buffer in which data is temporarily stored.

The method according to the various embodiments disclosed herein may be provided in a computer program product. The computer program product may be traded between a seller and a buyer as a product. The computer program product may be distributed in the form of a machine-readable storage medium (e.g., compact disc read only memory (CD-ROM)), or may be distributed (e.g., download or upload) through an application store (e.g., Play Store™) online or directly between two user devices (e.g., smartphones). In the case of online distribution, at least a portion of the computer program product (e.g., downloadable app) may be stored at least semi-permanently or may be temporarily generated in a storage medium, such as a memory of a server of a manufacturer, a server of an application store, or a relay server.

Although various example embodiments of the disclosure have been described with reference to the accompanying drawings, it will be understood that the various example embodiments are intended to be illustrative, not limiting. It will be further understood by those skilled in the art that various modifications may be easily made without departing from the true spirit or full scope of the disclosure including the appended claims and their equivalents. It will also be understood that any of the embodiment(s) described herein may be used in conjunction with any other embodiment(s) described herein.

What is claimed is:

1. A dishwasher, comprising:
a cabinet;
a tub disposed in the cabinet;
a sump disposed below the tub;
a deionizer, comprising at least one electrode, configured to produce soft water using raw water supplied from a water source, and supply the soft water to the sump;
a plurality of flow paths comprising at least one pipe and/or at least one hose configured to allow the raw water, the soft water, and used water collected in the sump to flow;
a plurality of valves disposed in each of the plurality of flow paths; and
a controller including at least one processor, comprising processing circuitry, individually and/or collectively, configured to control the plurality of valves to allow the deionizer to be regenerated using the raw water or the used water, in at least one of a washing process or a rinsing process.

2. The dishwasher of claim 1, wherein the plurality of valves comprises:
a first valve configured to open or close a first flow path configured to supply the raw water to the deionizer;
a second valve configured to open or close a second flow path configured to supply the soft water produced by the deionizer to the sump;
a third valve configured to open or close a third flow path configured to drain the used water collected in the sump to an outside;
a fourth valve configured to open or close a fourth flow path configured to supply the used water to the deionizer; and
a fifth valve configured to open or close a fifth flow path configured to connect the second flow path and the third flow path.

3. The dishwasher of claim 2, wherein the controller is configured to close the second valve, the third valve, and the fourth valve, and open the first valve and the fifth valve, to regenerate the deionizer using the raw water, in at least one of the washing process or the rinsing process.

4. The dishwasher of claim 3, wherein the controller is configured to control the plurality of valves to allow the deionizer to be regenerated using the raw water, while the soft water stored in the sump is sprayed into the tub, in at least one of the washing process or the rinsing process.

5. The dishwasher of claim 3, wherein the controller is configured to:
open the first valve and the second valve and close the third valve, the fourth valve and the fifth valve to supply the soft water to the tub at a start of the washing process and a start of the rinsing process, and
close the second valve and open the fifth valve based on a defined amount of the soft water being stored in the tub.

6. The dishwasher of claim 2, wherein the controller is configured to close the first valve, the second valve, and the third valve, and open the fourth valve and the fifth valve, to allow the deionizer to be regenerated using the used water, in at least one of the washing process or the rinsing process.

7. The dishwasher of claim 6, wherein the controller is configured to control the plurality of valves to allow the deionizer to be regenerated using the used water, during at least one of a draining operation of the washing process or a draining operation of the rinsing process.

8. The dishwasher of claim 6, wherein the controller is configured to control the plurality of valves to allow the deionizer to be regenerated using the used water, in a last rinsing process of a plurality of rinsing processes.

9. The dishwasher of claim 6, further comprising:
a turbidity sensor configured to detect a turbidity of the used water,
wherein the controller is configured to determine regeneration of the deionizer using the used water, based on the turbidity of the used water being less than or equal to a defined threshold value.

10. The dishwasher of claim 2, wherein one end of the fourth flow path is connected to the first flow path, another end of the fourth flow path is connected to the third flow path,
a first branching point where the third flow path and the fourth flow path are connected is located closer to a drain of the sump than a second branching point where the third flow path and the fifth flow path are connected, and
the third valve is located between the first branching point and the second branching point.

11. The dishwasher of claim 2, further comprising:
a water tank; and
a sixth valve configured to open or close a sixth flow path configured to connect the third flow path and the water tank,
wherein the controller is configured to close the sixth valve after opening the sixth valve for a defined time to allow the used water to be stored in the water tank while a plurality of rinsing processes are performed, and
open the sixth valve to allow the deionizer to be additionally regenerated using the used water stored in the water tank, to additionally regenerate the deionizer after completion of a last rinsing process of the plurality of rinsing processes.

12. The dishwasher of claim 1, further comprising:
a drain filter connected to a drain of the sump.

13. The dishwasher of claim 1, further comprising:
a water purification filter connected to an inlet of the deionizer.

14. A method for controlling a dishwasher comprising a tub, a sump disposed below the tub, a deionizer configured to produce soft water using raw water supplied from a water source and supply the soft water to the sump, a plurality of flow paths configured to allow the raw water, the soft water, and used water collected in the sump to flow, and a controller including at least one processor, comprising processing circuitry, the method comprising:
supplying the soft water to the sump by controlling the deionizer and a plurality of valves arranged on the plurality of flow paths by the controller in a washing process and a rinsing process, so as to wash dishes placed in the tub; and
performing regeneration of the deionizer using the raw water or the used water in at least one of the washing process or the rinsing process, by controlling the plurality of valves by the controller.

15. The method of claim 14, wherein the performing of regeneration of the deionizer using the raw water comprises:
opening a first valve to open a first flow path configured to supply the raw water to the deionizer;
closing a second valve to close a second flow path configured to supply the soft water produced by the deionizer to the sump;
closing a third valve to close a third flow path configured to drain the used water collected in the sump to an outside;
closing a fourth valve to close a fourth flow path configured to supply the used water to the deionizer; and
opening a fifth valve to open a fifth flow path configured to connect the second flow path and the third flow path.
